(19) United States
(12) Patent Application Publication
(10) Pub. No.: US 2026/0066548 A1
(43) Pub. Date: Mar. 5, 2026

(54) ANTENNA REFLECTOR WITH CARBON NANOTUBE ELASTOMER COMPOSITE

(71) Applicant: Eagle Technology, LLC, Melbourne, FL (US)

(72) Inventors: Ian Peterson, Rochester, NY (US); Andrew Bucossi, Irondequoit, NY (US)

(21) Appl. No.: 18/818,935

(22) Filed: Aug. 29, 2024

(51) Int. Cl. H01Q 15/20; H01Q 15/14

(52) U.S. Cl. CPC H01Q 15/20; H01Q 15/141

(57) ABSTRACT

A deployable reflector system comprising a support structure and a reflector surface connected to the support structure. The reflector surface comprised of a carbon nanotube elastomer composite with high bending flexibility out-of-plane and a low modulus of elasticity. The support structure configured to transition from a compact stowed configuration to a larger deployed configuration.

### BACKGROUND

### Description of the Related Art

Reflector antenna systems are used on satellites and other systems that communicate using radio-frequency (RF) energy and other types of electromagnetic energy. In a reflector antenna system, a reflector surface is provided that focuses the RF energy that is being received or transmitted. In some scenarios, a reflector may have a generally parabolic shape. To support the reflector surface, various conventional antenna structures may be provided. For example, these antenna support structures include radial rib designs, folding rib designs, and designs which utilize a hoop. In many of these antenna designs, the structure is made to support to a flexible antenna reflector surface attached thereto. For example, a plurality of battens, cords, wires, guidelines, or other tensile members may be used to couple the flexible antenna reflector surface to the structure. In some scenarios, the battens, wires and/or guidelines define and maintain the shape of the flexible antenna reflector surface when it is deployed. In the case of a deployable reflector the antenna structure is often designed to be collapsible so that it can be transitioned from a stowed configuration to a deployed configuration. In the stowed position, the structure is collapsed into a relatively small space as compared to when fully deployed.

The trend in the space antennas market is a continued push towards higher frequency applications and larger size reflectors. This trend has created many design challenges. For example, reflector surfaces used in many conventional antenna designs are made of woven gold-plated molybdenum mesh (Au/Mo) mesh. However, certain performance characteristics of Au—Mo mesh can degrade at higher frequencies. Cost of such Au/Mo mesh reflectors can also be a concern. Other reflector surfaces can be used can be used in place of Au/Mo mesh, but these surface materials can themselves create design challenges with regard to suitable methods and systems for stowage and deployment.

Other conventional reflector surfaces may be formed of knitted mesh materials comprising a gold plated tungsten wire (e.g., such as that disclosed in U.S. Pat. No. 4,609,923) or a gold plated molybdenum wire. These gold plated wire mesh materials have two inherent deficiencies for antenna applications. First, the gold plated wire has a high solar absorptivity to hemispherical emissivity ratio (e.g., αₛₒₗₐᵣ/ε_{H}=8) which results in high mesh temperatures.

Secondly, the gold plated wire has a relatively high Coefficient of Thermal Expansion (“CTE”) (e.g., approximately 4.5 ppm/C° for the tungsten wire and approximately 5.0 ppm/C° for the molybdenum wire). The high αₛₒₗₐᵣ/ε_{H} ratio in conjunction with the high CTE results in thermal distortion of the antenna reflector due to on-orbit temperatures. This thermal distortion degrades antenna performance, for example, by reducing gain and increasing sidelobe levels.

### SUMMARY

The present document concerns a deployable reflector system. The deployable reflector system includes a support structure and a reflector surface connected to the support structure. The reflector surface is comprised of a carbon nanotube elastomer composite with high bending flexibility out-of-plane and a low modulus of elasticity. The support structure is configured to transition from a compact stowed configuration to a larger deployed configuration.

The present document also concerns a method for deploying a reflector system. The method comprises: configuring a reflector surface in a compact state by crumpling or folding a carbon nanotube elastomer composite with high bending flexibility out-of-plane and a low modulus of elasticity; securing the reflector surface to a support structure; transitioning the support structure from a stowed configuration to a deployed configuration; and allowing an automatic extension of the carbon nanotube elastomer composite from the compact state to an extended state when a tension force is applied to at least a portion of the carbon nanotube elastomer composite during said transitioning.

### BRIEF DESCRIPTION OF THE DRAWINGS

The present solution will be described with reference to the following drawing figures, in which like numerals represent like items throughout the figures.

FIG. 1 is a perspective view of a deployed reflector antenna system which includes a reflector surface formed of a carbon nanotube and elastomer composite.

FIG. 2 is a perspective view of the deployed hoop assembly.

FIG. 3 is a top view of the deployed hoop assembly.

FIG. 4A is a perspective view of the hoop assembly and reflector surface in a collapsed or stowed condition.

FIG. 4B is a cross-sectional view of the hoop assembly and reflector surface in FIG. 4A taken along line 4B-4B.

FIG. 5 is a side view of a portion of the deployed hoop assembly which is enlarged to show certain details.

FIG. 6 is a perspective view of a portion of the deployed hoop assembly which is enlarged to show certain details.

FIG. 7 is a drawing which shows how the reflector surface can extend from a compact folded state to a fully unfolded state.

FIG. 8 provides an illustration of a carbon nanotube elastomer composite.

FIGS. 9A-9B (collectively referred to as “FIG. 9”) provides a flow diagram of an illustrative method for making an antenna reflector using a carbon nanotube elastomer composite.

FIG. 10 provides an illustration an illustration of a method for making an antenna reflector using a carbon nanotube elastomer composite.

FIG. 11 provides a side view of an illustrative rigid base structure.

FIG. 12 provides a top view of the rigid base structure shown in FIG. 11.

FIGS. 13-25 provide illustrations that are useful for understanding a method for making an antenna reflector using a carbon nanotube elastomer composite.

FIG. 26 provides a flow diagram of an illustrative method for deploying a reflector system.

### DETAILED DESCRIPTION

It will be readily understood that the components of the systems and/or methods as generally described herein and illustrated in the appended figures could be arranged and designed in a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Carbon nanotube (CNT) reflector surfaces provide the benefit of reduced cross-polarization loss at high frequencies compared to state-of-the art gold-moly mesh surfaces. Enabling deployable CNT reflector surfaces requires the development of a CNT composite material that is highly flexible to enable certain stowing strategies. Current CNT composite materials employ high stiffness thermoset epoxy resins as the matrix material that encapsulates the CNT sheets. Stiff epoxy resin materials may not be suitable for applications that require significant out-of-plane bending when stowing a reflector.

The present solution concerns systems and methods for making articles comprising a CNT elastomer composite material with low stiffness. The CNT elastomer composite material is also referred to herein as a CNT/elastomer material. The elastomer can include, but is not limited to, silicone. The CNT/elastomer material comprises highly densified CNT sheet(s) sandwiched between layers of elastomer. The present solution is described herein in relation to antenna applications. The present solution is not limited in this regard. The present solution disclosed herein can be used in other applications in which a contoured RF reflective material with a low αₛₒₗₐᵣ/ε_{H} ratio and/or a low CTE is needed.

In an antenna application, the present solution concerns a deployable antenna reflector system incorporating a reflector surface formed of a flexible thin sheet comprised of a CNT/elastomer material. This sheet is referred to herein as a CNT/elastomer sheet. A mesh pattern may be laser cut in the CNT layer(s) of the CNT/elastomer material. Laser cutting allows for a relatively wide range of possible openings per inch (e.g., 10-100 openings per inch) in a mesh material. Additionally, the laser cutting provides mesh materials with areal densities that are less than ten percent of the areal density of a mesh material formed using the gold plated tungsten or molybdenum wire with a diameter equal to the diameter of the CNT yarn.

The antenna reflector system described herein includes a support structure which is designed to automatically transition from a compact stowed configuration to an extended configuration in which the support structure is fully deployed. The low stiffness of the CNT/elastomer material allows the reflector to be stowed and deployed with reduced force. The CNT/elastomer sheet is stowed in a small packaging size by crumpling or folding the sheet to achieve a compact stowed size. The CNT/elastomer sheet may be crumpled or folded in any manner selected in accordance with a given application. The CNT/elastomer sheet is configured such that at least the CNT layers are not damaged or deformed while the sheet is being crumpled and/or folded. A folding pattern of the CNT/elastomer sheet may or may not be a predetermined folding pattern. The folding pattern can be dynamically determined at the time of transitioning the CNT/elastomer material in its stowed state. The folding pattern may be the same or different each time the CNT/elastomer material is transitioned to its stowed state.

The CNT/elastomer sheet can automatically deploy to its full extent concurrent with the transition of the support structure to its deployed configuration. For example, portions of the CNT/elastomer sheet can be secured to the support structure so that the CNT/elastomer sheet automatically unfolds from its compact stowed size to its fully extended condition in response to the transition of the support structure from its stowed configuration to its deployed configuration. In the deployed configuration, the reflector surface may have an elliptical, parabolic or other shape. A backing structure of the CNT/elastomer material dictates the overall shape and/or cross-sectional profile of the reflector. The low CTE of the CNT/elastomer material limits stress due to a CTE mismatch between the surfaces and the backing structure.

The support structure for the antenna reflector system may comprise a hoop or hoop assembly. The deployable antenna reflector described herein may comprise a hoop assembly which facilitates stowage and deployment of a reflector surface formed of the CNT/elastomer material. Other types of support structures can also be used to facilitate stowage and deployment of a folded reflector surface. Different support structures having different configurations and/or deployment characteristics can require different crumpling techniques and/or a different sheet folding patterns. In each instance, the crumpling technique and/or folding pattern may be specifically chosen in accordance with the configuration of the particular support structure to facilitate automatic deployment.

The described arrangement facilitates several improvements in the field of deployable reflector systems as compared to conventional reflector designs that comprise reflector surfaces made of woven gold-plated molybdenum (Au/Mo) mesh. For example, the system can facilitate reduced cross-polarization loss at higher frequencies.

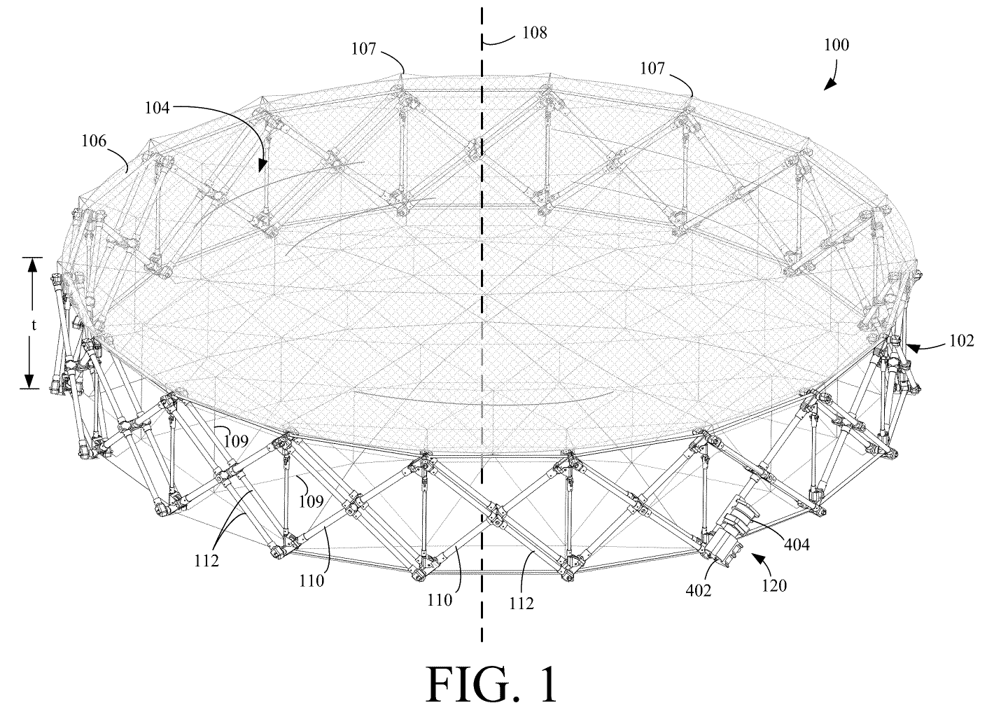

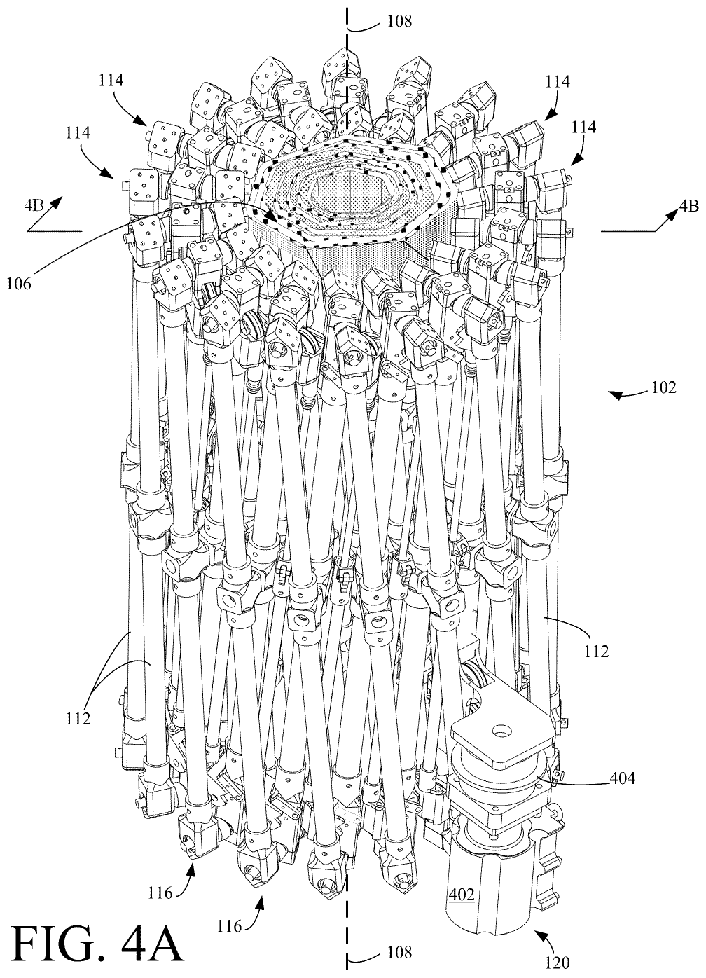

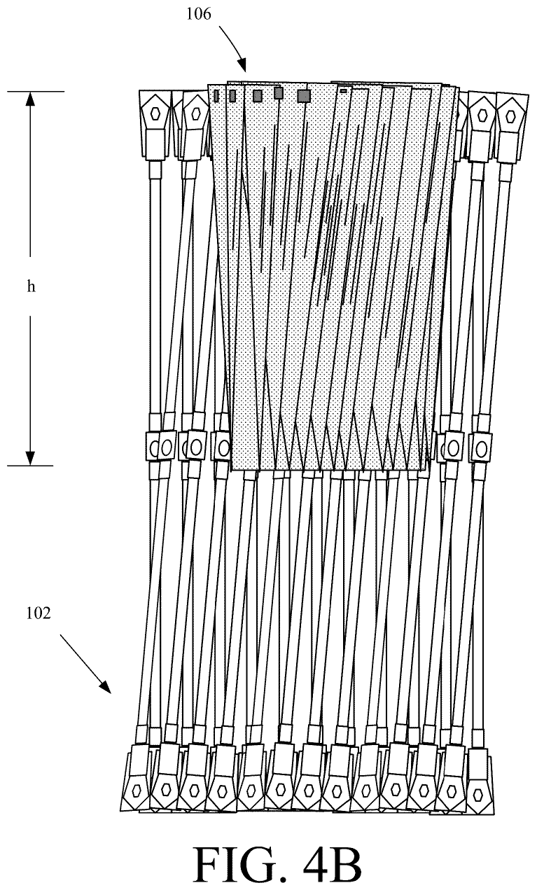

A deployable reflector system (DRS) 100 will now be described with reference to FIGS. 1-4. The DRS 100 is comprised of a support structure which in this example is a hoop assembly 102. The hoop assembly 102 defines an interior space 104 for a deployable reflector surface 106. The deployable reflector surface is configured to reflect Electro-Magnetic (“EM”) energy in the radio wave band of the EM spectrum. The hoop assembly 102 is configured so that it can deploy to an expanded condition shown in FIGS. 1-3, and can collapse into a stowed condition shown in FIGS. 4A and 4B. To enhance the clarity of this disclosure, the reflector surface 106 is omitted in some of the drawing figures.

### Illustrative Support Structure

In the stowed condition, the hoop assembly can be sufficiently reduced in size such that it may fit within a compact space (e.g., a compartment of a spacecraft or on the side of a spacecraft). The hoop assembly 102 can have various configurations and sizes depending on the system requirements. In some scenarios, the hoop assembly 102 can define a circular structure as shown in FIG. 1, and in other scenarios the hoop assembly can define an elliptical structure.

The hoop assembly 102 may be configured to be a self-deploying system.

The exact configuration of the hoop assembly 102 is not critical. Any hoop assembly can be employed provided that it is capable of facilitating stowage and deployment of the reflector surface 106 as described herein. Accordingly, it should be understood that the particular hoop assembly shown and described herein is presented merely as one possible example of a hoop assembly which can be used to stow and deploy a folded CNT/elastomer reflector surface.

The hoop assembly 102 is comprised of a plurality of link elements which are disposed about a central, longitudinal axis 108. The link elements can comprise two basic types which are sometimes referred to herein as a first link element 110, and a second link element 112. The link elements are elongated rigid structures which extend between hinge members 114, 116 disposed on opposing ends of the link elements. For example, in some scenarios the link elements can be comprised of elongated rigid tubular structures formed of a rigid lightweight material. Exemplary materials which can be used for this purpose include metallic or a Carbon Fiber Reinforced Polymer (CFRP) composite material.

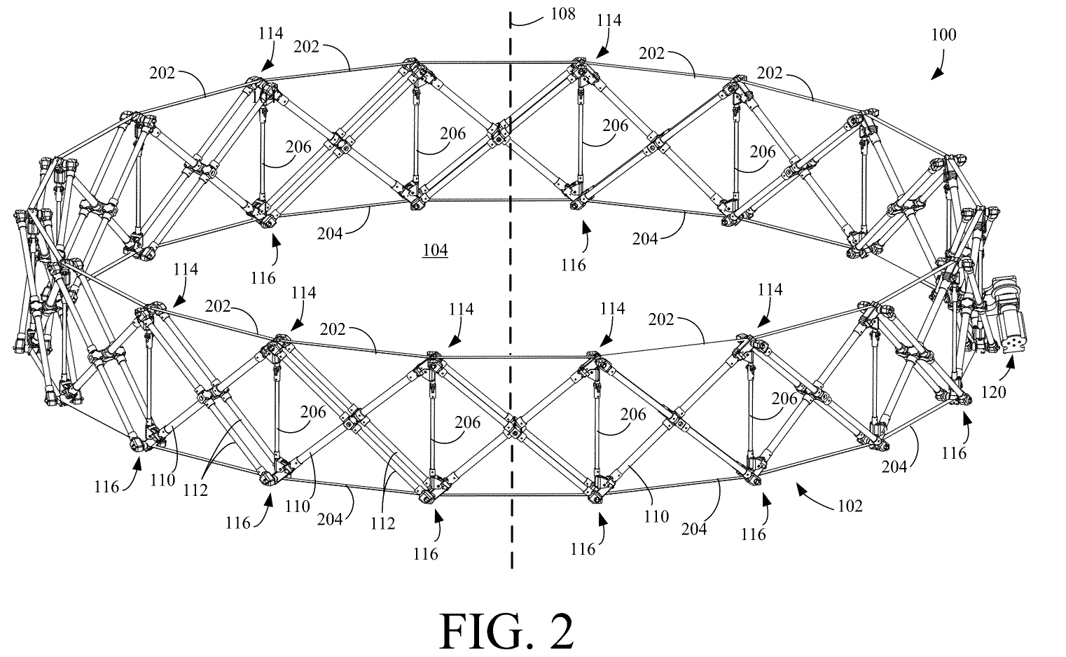

As may be observed in FIGS. 4A and 4B, the arrangement of the hoop assembly is such that the hoop can have a collapsed condition wherein the first and second link elements extend substantially parallel to each other, and an expanded condition wherein the link elements define a circumferential hoop around a central axis. In some scenarios, the substantially parallel condition referred to herein can include a condition in which the axial length of the first and second link elements each form an angle of less than about 5 to 10 degrees relative to the central axis 108 of the hoop assembly. Further, it can be observed by comparing FIG. 2 and FIG. 4A that a circumference defined by the hoop assembly 102 in the expanded condition can be much greater as compared to the circumference defined by the hoop in the collapsed condition.

The reflector surface 106 is formed of a thin highly flexible sheet or web comprised of a CNT/elastomer material. The CNT/elastomer material is conductive and highly reflective of radio frequency signals. Due to the highly flexible nature of the CNT/elastomer material, it is easily deformable and foldable. Consequently, the reflector surface can be compactly stowed by crumping the CNT/elastomer material and/or applying a folding pattern. For example, in some scenarios, the CNT/elastomer sheet material can be stored in a folded condition within the circumference of the hoop assembly when folded or collapsed for stowage.

The CNT/elastomer material is secured at attachment points 107 along its periphery to the hoop assembly 102. The material is also attached at various locations using battens to shaping/support cords 109 disposed within the periphery of the hoop assembly. Consequently, when the hoop assembly is in the expanded condition, the reflector surface is expanded to a shape that is intended to concentrate RF energy in a desired pattern. For example, the reflector surface can be controlled so as to form a parabolic surface when the hoop assembly is in the expanded or deployed condition.

In order to shape the reflector 106 into a parabolic surface (or other reflecting surface shape), the hoop assembly 102 may have a thickness t which extends in the longitudinal direction aligned with the central axis 108. As such, the hoop assembly 102 will include structural elements which extend some predetermined distance out of a plane defined by the peripheral edge of the reflector surface. This distance is usually greater than the depth of the reflector as measured along the axis 108. The hoop assembly as described herein must also have a degree of bending stiffness to allow the reflector to conform to the required shape. For a system using symmetric optics where RF energy is focused along the longitudinal axis of the reflector 108, the structure 102 will be circular when deployed. For systems requiring an ‘offset’ configuration where the RF energy is focused on a line parallel to the longitudinal axis 108 but located outside the perimeter of the hoop, the structure 102 is elliptical in shape.

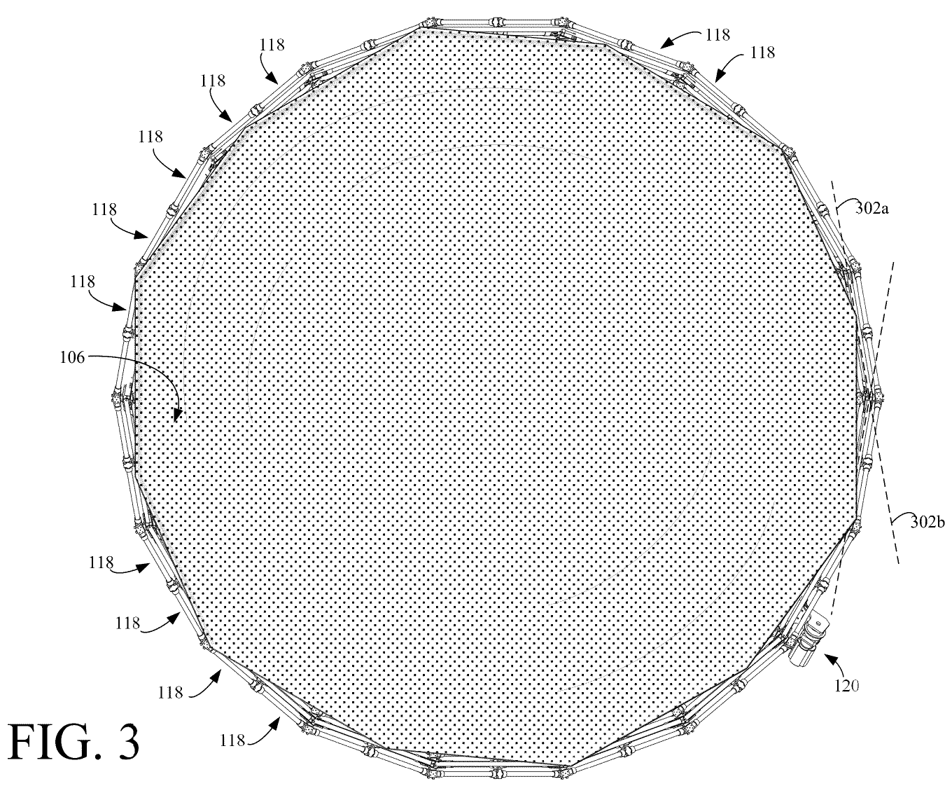

FIG. 3 shows the hoop assembly 102 in the expanded condition. The arrangement of the link elements 110, 112 is such that the assembly will define a plurality of N sides 118, where N is an integer. The actual value of N can vary depending on a various design considerations.

Usually for reasons of symmetry, it is advantageous to select a value for N that is evenly divisible by two. The number of sides can be advantageously selected by a designer for each application to optimize packaging and weight.

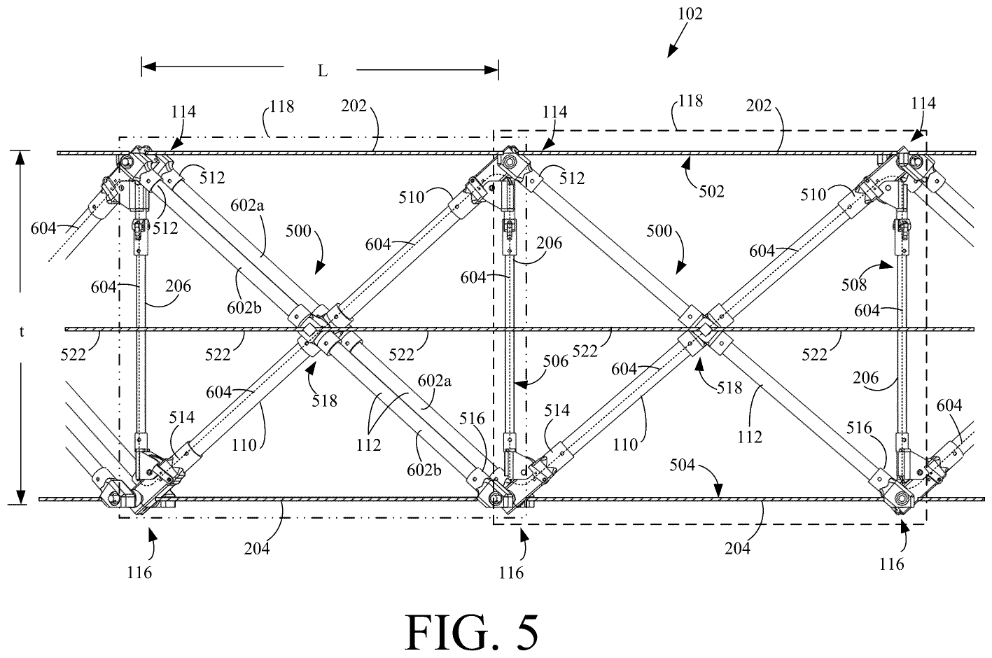

As shown in FIG. 5, the arrangement of link elements allows each of the N sides 118 to be understood as defining a rectangle or rectangular shape. As such, the sides 118 are also sometimes referred to herein as rectangular sides. Each rectangular side is comprised of a top 502, a bottom 504 and two opposing, vertical edges 506, 508 which generally define the outer periphery or edges of each rectangular side. As used herein, the word “vertical” is used to indicate a direction which is generally aligned with the direction of the central, longitudinal axis 108.

The top and bottom edges 502, 504 may be aligned with a top cord 202 and a bottom cord 204 when the hoop assembly is in a deployed condition. Likewise, the two opposing vertical edges 506, 508 may be aligned with aligned with side edge tension elements 206. Such a scenario is illustrated in FIG. 3 where the elongated length of the top and bottom cords correspond to the top and bottom edges 502, 504, and the vertical side edges correspond to the side tension elements 506, 508. But in some scenarios, these various edges may not correspond to these structural elements and may instead correspond to imaginary lines drawn between hinge members 114, 116 disposed on opposing ends of the link elements. In some scenarios, the top, bottom and two opposing edges can all be of the same length such that the rectangular shape is a square. However, in other scenarios, the rectangular side can have a top and bottom which are of a length different from the two vertical edges.

As may be observed in FIGS. 3 and 5, the N sides are disposed adjacently, edge to edge, and extend circumferentially to define a periphery of the hoop assembly 102. Further, the opposing edges 506, 508 of each side can extend substantially along the full axial depth or thickness t of the hoop assembly 102 in a direction aligned with the hoop longitudinal axis 108. As such, a top 502 of each side will be substantially aligned along a top plane of the hoop assembly which extends in directions orthogonal to the hoop longitudinal axis. Similarly, a bottom edge 504 of each side will be substantially aligned along a bottom plane of the hoop assembly 102 which extends in directions orthogonal to the hoop longitudinal axis. When the hoop assembly is expanded, the bottom plane is spaced a distance t from the top plane.

Each of the N sides is defined in part by an X-member 500 which is comprised of a first and second link element 110, 112. As shown in FIG. 5, the first and second link elements are disposed in a crossed configuration. More particularly, the first and second link elements can be respectively disposed on opposing diagonals of the rectangle which defines each side. As such, each of the first and second link elements 110, 112 can respectively include a top end 510, 512 which extends substantially to a top corner defined by the top 502 and one side 506, 508 of the side. Each of the first and second link elements can also respectively include a bottom end 514, 516 which extends substantially to a bottom corner of the rectangle defined by the bottom 504 and sides 506, 508 of the side.

A pivot member 518 is connected at a pivot point of the first and second link elements. The pivot point is located intermediate of the two opposing ends of each link element. For example, the pivot point is disposed at approximately equal distance from the opposing ends of the first link element, and at approximately equal distance from the opposing ends of the second link element. As such, the pivot point can located approximately at a midpoint of each element.

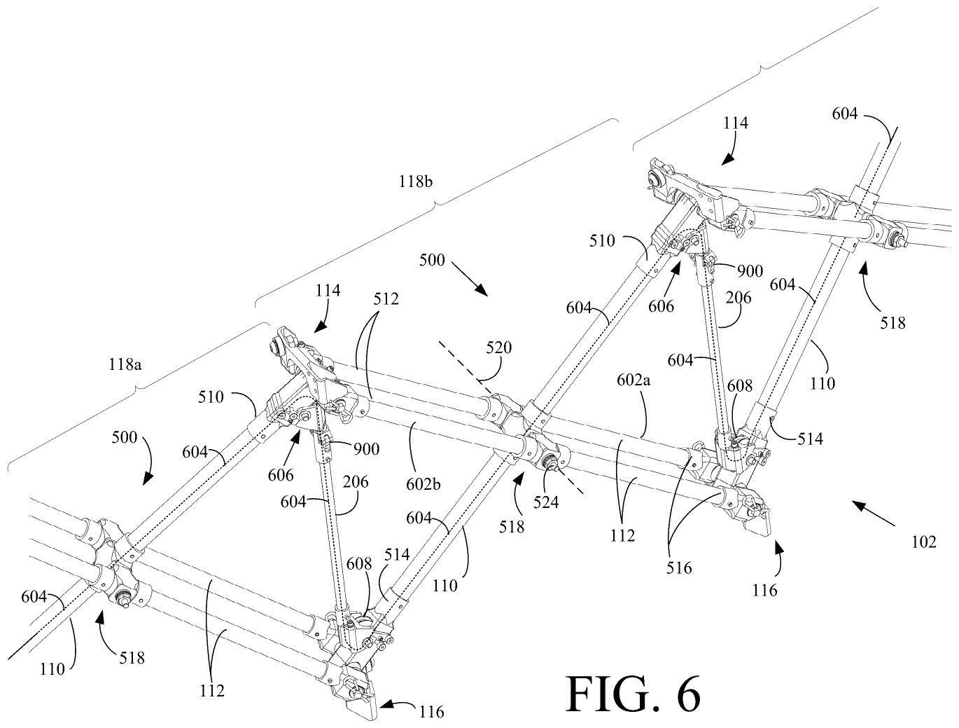

The pivot member 518 is configured to facilitate pivot motion of the first link element 110 relative to the second link element 112 about a pivot axis 520 in FIG. 6 when the hoop assembly transitions between the collapsed condition and the expanded condition. As such, the first and second link elements which form the X-member can move in a manner which mimics the operation of a pair of scissors. According to one aspect, the pivot axis 520 of the X-member can be approximately aligned with a radial axis 300 (as shown in FIG. 3) of the larger overall hoop assembly, where the radial axis extends orthogonally from the central axis. The exact configuration of the pivot member 518 is not critical provided that it facilitate the pivot or scissor motion described herein. In some scenarios, the pivot member can be a shaft or an axle 524 on which one or both of the first and second link elements 110, 112 are journaled to facilitate the pivot motion described herein. As such, one or both of the first and second link elements 110, 112 can also include a bearing surface which facilitates rotation of the link member on the pivot member.

The hinge members 114, 116, which are sometimes referred to herein as hinges, are disposed at opposing ends of the first and second link elements 110, 112 and connect adjoining ones of the X-members 500 at the top and bottom corners associated with each side. As shown in FIGS. 5-6, the first link element 110 of each X-member 500 is connected at its top end 510 to a second link element 112 of an X-member associated with a first adjacent side. The same first link element 110 is connected at its bottom end 516 to the second link element 112 of a second one of the X-members associated with a second adjacent side. This arrangement allows the ends of each link member to pivot relative to the link elements comprising an adjacent side so that the scissor motion of each X-member as described herein can be facilitated.

As is best shown in FIGS. 5-6, the second link element 112 of each X-member 500 is comprised of a plurality of elongated structural members 602a, 602b. In some scenarios, this plurality of elongated structural members can extend in parallel with each other as shown. A first one of the elongated structural members 602a extends on an inner side of the first link element 110 which is closest to the central axis 108 of the hoop assembly 102. The second one of the elongated structural members 602b can extend on an outer side of the first link element 110 which is furthest from the central axis of the hoop. The pivot member 518 is configured so that it will facilitate pivot motion of each of the plurality of elongated structural members 602a, 602b relative to the first link element such that the two members can pivot together about the pivot axis 520.

The elongated structural members 602a, 602b may be connected to a common or shared hinge 114 at a top end 512 of the second link element 112, and a common or shared hinge 116 at a bottom end 516 of the second link element. As such, the elongated structural members 602a, 602b can share a common top hinge 114 and a common bottom hinge 116. The common top hinge 114 in a side 118b is connected to a top end 510 of the first link element 110 comprising the X-member in a first adjacent side 118a. The shared or common bottom hinge 116 is connected to a bottom end 514 of the first link element 110 comprising the X-member in a second adjacent side 118c.

In a hoop assembly as described herein, adjacent ones of the sides 118 will necessarily be aligned in different planes. This concept is best understood with reference to FIG. 3 which shows that adjacent sides 118 will be aligned in different planes 302a, 302b.

Accordingly, the arrangement of the hinges used to connect the X-members 500 is selected so as to minimize any potential binding of the hoop assembly 102 during transitions between its stowed condition and deployed condition. Various arrangements for hinge members 114, 116 can be used to facilitate this purpose.

Each rectangular side 118 comprising the hoop assembly is further defined by a plurality of tension elements (FIG. 5) which extend around the periphery of the side and apply tension between opposing ends of the first and second link elements in directions aligned with the top, bottom and two opposing edges. More particularly, as shown in FIGS. 2 and 5, the tension elements include a top cord 202 which extends along the top of the side between top ends 510, 512 of the first and second link elements, and a bottom cord 204 which extends along the bottom of the side between bottom ends 514, 516 of the first and second link elements. The top cord 202 is substantially aligned with the top plane defined by the hoop assembly and the bottom cord is substantially aligned with the bottom plane defined by the hoop assembly. The top cord for each side can be secured to securing hardware (not shown) on opposing ones of the hinge members 114, and the bottom cord for each side can be secured to securing hardware (not shown) on opposing ones of the hinge members 116. The top and bottom cords are tension-only elements, meaning that they are configured exclusively for applying tension between the opposing ends of the link elements. As such the top and bottom cord 202, 204 can be flexible tensile elements, such as cable, rope or tape.

To control the deployed position of each side of the expanded hoop, it is important that the top and bottom cords 202, 204 be stiff elements, meaning that they are highly resistant to elastic deformation when under tension. While slack in the collapsed state, these elements are selected to quickly tension at their expanded length. As such, they act as a ‘hard-stop’ to limit further hoop expansion by restricting the distance between hinges 114 at the top and 116 at the bottom. To effect ‘hard-stop’ behavior in these elements, the amount of stretch between the slack state and tension state should be small. This high degree of control over hinge position will in turn facilitate the precision of the attached surface 104 in FIG. 1.

A separate top cord 202 can be provided between the link elements 110, 112 comprising each side 118. Similarly, each side 118 can be comprised of a separate bottom cord 204 which extends between the bottom ends of the first and second link elements. But in other scenarios, it can be advantageous to use a single common top cord 202 which extends in a loop around the entire hoop assembly. Such a top cord 202 can then be secured or tied off at intervals at or near the top ends 510, 512 of the first and second link elements 110, 112. For example, the top cord 202 can be secured at intervals to securing hardware associated with each of the top hinge members 114. Consequently a portion or segment of the overall length of the single common top cord loop will define a top tension element for a particular side. A similar arrangement can be utilized for the bottom cord 204. Since the top and bottom cord have significant stiffness (resistance to elastic deformation) as explained above and are attached to opposing hinge elements at or near the top and bottom of each X-member, their length Ld will necessarily limit the maximum deployed or expanded rotation of the first and second link elements 110, 112 about a pivot axis 524.

Each side 118 is further defined by opposing vertical edge tension elements 206 which extend respectively along the two opposing edges of the side. The edge tension elements 206 can extend respectively along the two opposing vertical edges of each side. The edge tension elements 206 are configured for applying tension between the opposing top and bottom ends of the link elements 512, 514 and 510, 516 when they are in a latched condition.

Referring once again to FIGS. 5-6, the hoop assembly also includes at least one deployment cable 604. The deployment cable 604 can be a continuous cord which extends around the perimeter of the hoop assembly 102 to drive transition of the hoop assembly from the collapsed condition to the expanded condition. The deployment cable 604 is a flexible tensile element, such as cable, rope or tape. Portions of the deployment cable 604 extend along the two opposing vertical edges 506, 508 of each side. Under some conditions, these portions of the deployment cable can also be understood to function as edge tension elements. More particularly, these portions of the deployment cable 604 will function as the edge tension elements when the edge tension elements 206 are in an unlatched state. These portions of the deployment cable may be disposed within a central bore of each edge tension element 206 such that the deployment cable 604 and the edge tension element 206 are substantially coaxial.

In each side 118, the control cable extends diagonally between the two opposing edges 506, 508, along the length of the first link element 110. For example, the deployment cable 604 in such scenarios can extend through a bore formed in the first link element 110, where the bore is aligned with the elongated length of the first link element. Of course, other arrangements are also possible and it is not essential that the deployment cable extend through a bore of the first link element. In some scenarios, the control cable could alternatively extend adjacent to the first link element through guide elements (not shown).

Cable guide elements are provided to transition an alignment of the deployment cable from directions aligned with the opposing edges 506, 508 of each side, to a diagonal direction aligned with the first link element 110. In a scenario disclosed herein, a top guide element 606 and bottom guide element 608 are respectively disposed at the top and bottom ends of the first link element 119. The cable guide elements can be simple structural elements formed of a low friction guiding surface on which the deployment cable can slide. However, the cable guide elements can instead be selected to comprise a pulley that is designed to support movement and change of direction of a taught cord or cable.

As shown in the FIGS. 2, 3 and 4A, a deployment cable actuator 120 can comprise a motor 402 and a drum assembly 404. The deployment cable is wound about the drum, and the motor controls rotation of the drum. Both opposing ends of the deployment cable may be wrapped around the drum to facilitate winding of the cable. With the foregoing arrangement, the length of the deployment cable 604 extending around the perimeter of the hoop assembly (extended length) can be selectively varied by controlling the amount of cord wound about the drum. Decreasing the extended length of the deployment cable around the periphery of the hoop assembly will cause the hoop assembly to transition from a collapsed condition shown in FIG. 4 to an expanded condition shown in FIGS. 1 and 2. More particularly, as an increasing portion of the deployment cable is wound on the drum, the extended length of the cord will necessarily shorten and the opposing edges 506, 508 of each side 118 forming the hoop assembly will decrease in length. The foregoing action will result in expanding the radius of the hoop assembly until it reaches its deployed condition.

### Illustrative Folding Pattern

As noted above, the reflector surface 106 may be crumpled or folded when being transitioned to and being in its stowed configuration. This section of the document will describe an illustrative folding pattern for the reflector surface. The present solution is not limited to the particulars of the folding pattern. Other folding patterns can be used to fold the reflector surface. In some cases, no folding pattern is employed since the reflector surface is crumpled.

In FIGS. 4A and 4B, the reflector surface 106 is shown in its stowed configuration within the hoop assembly 102. FIG. 4B shows a cross-sectional view of the assembly in FIG. 4A, taken along line 4B-4B. In FIGS. 4A and 4B, the cords and related structure that attach the peripheral edge and other portions of the reflector surface 106 to points on the hoop assembly have been omitted for greater clarity.

It can be observed in FIGS. 4A and 4B that the reflector surface 106 when in its stowed configuration may be intricately folded in accordance with a folding pattern. The folding pattern may be selected to permit automatic expansion of reflector surface 106 in the radial direction (relative to axis 108) when the hoop assembly (to which the reflector is attached) transitions from a compact stowed configuration to an extended or deployed configuration.

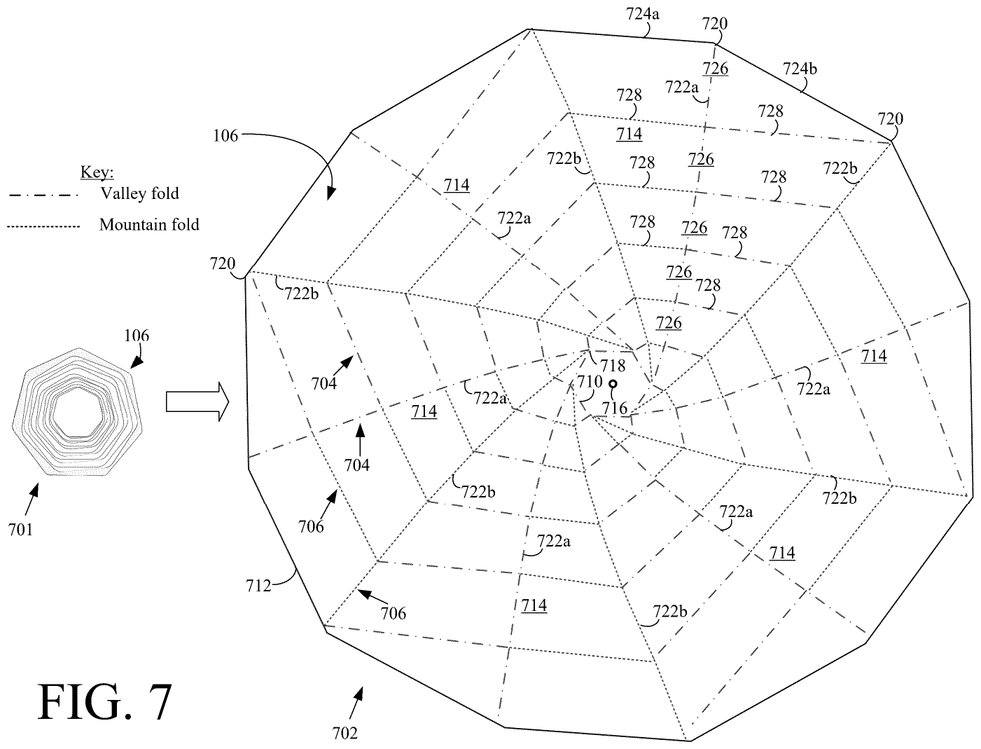

Shown in FIG. 7 is a simplified example of a folding pattern which can be used to facilitate a transition of reflector surface 106 from folded or stowed configuration 701 to a fully deployed or extended configuration 702. Each of the dashed lines in FIG. 7 represents a fold line of the reflector when the reflector surface when in its folded or stowed configuration. Two types of folds may be used. The two types of folds include valley folds 704 (which define valley fold lines) and mountain folds 706 (which define mountain fold lines). A valley fold is a fold of the CNT/elastomer sheet material that forms a trench. In contrast, a mountain fold is a fold of the CNT/elastomer sheet material that forms a ridge.

The folding pattern is comprised of three primary elements. These elements include an inner polygon 710, an outer polygon 712, and a plurality of wedges 714. The inner polygon and the outer polygon have a common center point 716. The inner polygon will have a number of points or corners 718 defined by the value n, whereas the outer polygon will have a number of points or corners 720 defined by the value 2n. In the simplified example shown in FIG. 7, the inner polygon is a hexagon having six points (n=6), whereas the outer polygon is a regular dodecagon having twelve sides and twelve points (n=12).

Each wedge 714 includes a plurality of wedge fold lines 722a, 722b which extend in a direction away from points 718 of the inner polygon to points 720 of the outer polygon. More particularly, two wedge fold lines 722a, 722b originate from every point of the inner polygon to define a vertex. In each case, a first type of the two wedge fold lines 722a will be a valley fold line, and a second of the two fold lines 722b will be a mountain type fold line. Each of these two wedge fold lines respectively extends along a different path to a different one of two points of the outer polygon. A wedge 714 is defined by two adjacent ones of the second type wedge fold line 722b and two adjoining sides 724a, 724b of the outer polygon which connect end points of the two wedge fold lines. The second type of wedge fold lines respectively extend in a direction away from adjacent corners of the inner polygon 710 to alternate corners 720 of the outer polygon.

Each wedge 714 includes a plurality of segments 726. The segments are defined by a plurality of cross-folds which establish cross-fold lines 728. The cross-fold lines within a particular wedge are equally spaced and parallel to one another so as to extend linearly between opposing mountain type wedge fold lines. The cross-fold lines are advantageously spaced equidistant from each other along the length of the wedge fold lines 722b between the inner and outer polygons. The spacing or distance between adjacent cross-fold lines will determine a height h of the reflector surface 106 when it its stowed or folded configuration. The first type of wedge fold lines 722a divide each wedge into two approximately equal portions along a direction extending from the center of the inner polygon. Consequently, it may be observed that within each wedge 714 a particular parallel cross-fold line 728 will transition from a mountain type fold line to a valley type fold line when it crosses or intersects the first type wedge fold line 722a. As may be observed in FIG. 7, the cross-fold lines 728 of each segment 714 extend in a direction which is transverse to the cross-fold lines 728 of an adjacent segment.

Application of the folding pattern to the CNT material results in the stowed configuration 701, whereas unfolding of the CNT/elastomer sheet material results in the extended or deployed configuration 702. The unfolding operation of the CNT/elastomer material can be performed automatically. For example, a peripheral edge of the reflector surface can be secured at attachment points 107 along its periphery to the hoop assembly 102. When the hoop is radially expanded, a tension force is applied to edges of the reflector surface which result in an unfolding operation of the reflector surface.

The folding pattern shown in FIG. 7 is merely one possible example of a folding pattern which may be used to facilitate the stowed or folded configuration of a CNT/elastomer sheet reflector surface. The intricate folding pattern shown in FIG. 7 is well suited for an expandable hoop type of support structure. However, the solution is not intended to be limited to the particular pattern or support structure shown. Other folding patterns can also be used provided that the pattern facilitates a reduction of the CNT/elastomer sheet material to a compact stowed configuration which fits within the support assembly, and allows for automatic deployment of the reflector surface when the support assembly is extended for deployment. In this regard it will be understood that a different folding pattern may be used to accommodate different types of reflector support structures.

### Illustrative CNT/Elastomer Material

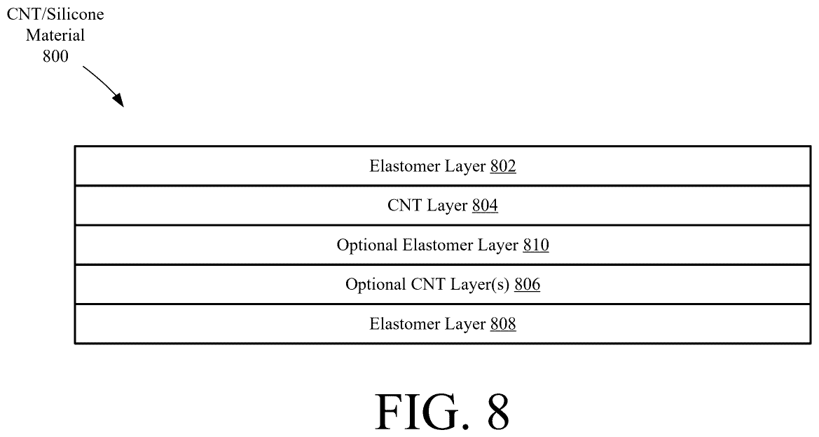

FIG. 8 provides an illustration of a CNT/elastomer material 800. The CNT/elastomer material 800 comprises one or more layers of a CNT material (“CNT layer(s)”) 804, 806 sandwiched between two layers of an elastomer (“elastomer layer(s)”) 802, 808, 810. The CNT material can, for example, (i) comprise a plurality of carbon nanotubes, (ii) is reflective of radio waves, (iii) has a solar absorptivity to hemispherical emissivity ratio (αₛₒₗₐᵣ/ε_{H} ratio) that is equal to or less than 2, and/or (iv) has a CTE that is equal to zero plus or minus 0.5 ppm/C°. The elastomer material can include, but is not limited to, silicone.

The CNT material of layer(s) 804, 806 has many advantages as compared to conventional mesh materials formed of gold plated molybdenum wire. The CNT material of layers 804, 806 can have an approximate thickness which can be between 0.1 mil and 10 mil.

For example a CNT material thickness in some scenarios can be about 1 mil. A significant advantage of a reflector formed of CNT material is that it can have an order of magnitude less through-thickness variation as compared to conventional woven Au—Mo wire mesh. To form a properly sized and shaped reflector surface, sheets of CNT material(s) can be bonded together to form larger sheets which support large reflector sizes. Further, the CNT material can be creased/folded to facilitate a folding pattern which allows for compact stowage and automatic deployment of the reflector surface.

In some scenarios, the CNT sheet material is comprised of a CNT mesh formed by laser cutting a mesh pattern in a sheet of CNT material. In other scenarios, the CNT mesh material is formed by knitting or weaving a CNT yarn. Laser cutting and the knittability/weavability of CNT yarns allows for a relatively wide range of possible openings per inch (e.g., 10-100 openings per inch) in a mesh material. Additionally, the laser cutting and CNT yarn provides mesh materials with areal densities that are less than ten percent of the areal density of a mesh material formed using the gold plated tungsten or molybdenum wire with a diameter equal to the diameter of the CNT yarn.

The CNT yarn includes, but is not limited to, a Miralon® yarn available from Huntsman Corporation of The Woodlands, Texas. The CNT yarn is strong, lightweight, and flexible. The CNT yarn advantageously has a low solar absorptivity to hemispherical emissivity ratio (e.g., αₛₒₗₐᵣ/ε_{H}=2). In some scenarios, the low αₛₒₗₐᵣ/ε_{H} ratio is less than 25% of the αₛₒₗₐᵣ/ε_{H} ratio of a gold plated tungsten or molybdenum wire. The CNT yarn also has a low CTE that is more than an order of magnitude less than a CTE of a gold plated tungsten or molybdenum wire. For example, the CNT yarn has a CTE equal to −0.3 ppm/C°. All of these features of the CNT yarn are desirable in antenna applications and/or space based applications.

The CNT mesh material may have a number of openings per inch selected based on the frequency of the EM energy to be reflected by the mesh antenna 100 (e.g., 10-100 openings per inch). In the CNT yarn scenarios, the mesh material comprises a knitted mesh material formed of a series of interlocking loops of CNT yarn. Notably, the present solution is not limited to knitted mesh materials. In other applications, the mesh material is a weave material rather than a knitted material. The weave material comprises a first set of filaments intertwined with a second set of filaments. Interstitial spaces or openings may be provided between the filaments.

In some scenarios, the knitted mesh material comprises a tricot type knit configuration. The present solution is not limited in this regard. Other types of knit configurations can be used herein instead of the tricot knit configuration. The tricot type knitted material may have an opening count of 10-100 per inch. Each opening is defined by multiple loops of CNT yarn. In some scenarios, the tricot type knitted material has an areal density that is less than ten percent of an areal density of a tricot type knitted mesh material formed using a gold plated tungsten or molybdenum wire with a diameter equal to the diameter of the CNT yarn.

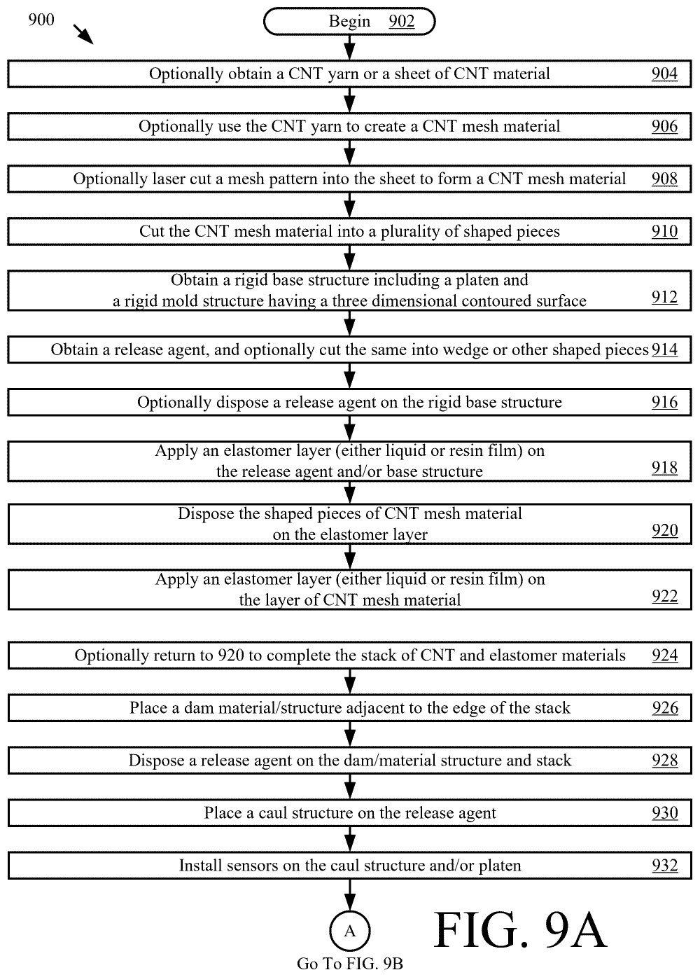

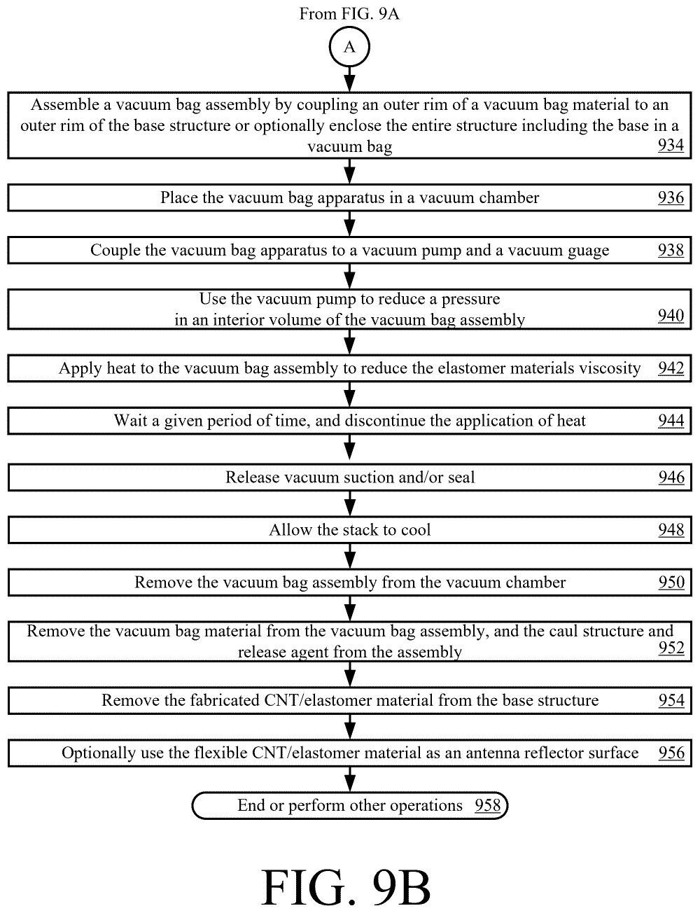

FIG. 9 provides a flow diagram of an illustrative method 900 for making an antenna reflector formed of a CNT/elastomer material. Using a CNT/elastomer material in high frequency RF reflector applications has a number of benefits. For example, CNT/elastomer materials with CTEs of near zero decrease thermal sensitivity and enable higher-frequency antenna reflectors. CNT/elastomer materials with solar reflectivity of approximately one facilitates formation of an antenna reflector that is less detectable by adversaries, increasing resiliency. Highly tailorable CNT/elastomer materials enable a wider design space (multi-material surfaces, frequency-specific meshes, etc.). Implementing a CNT/elastomer reflector surface requires forming a flat CNT/elastomer material into a concave shape. The CNT/elastomer material also allows for more flexibility in how the reflector surface is stowed.

In this regard, it should be noted that the CNT/elastomer material can be crumpled, folded or otherwise bent without any damage to the CNT layers of the material. As such, the reflector surface no longer needs a predetermine folding pattern, and can simply be crumpled, folder or otherwise bent in any manner when placing the reflector surface in a stowed state. The CNT/elastomer material also: has a reduced out-of-plane stiffness of the composite material compared to epoxy resin CNT sheet composites; maintains mechanical properties of the bare CNT sheet within the composite; has a high in-plane stiffness and strength; is formable into complex-curve shapes (e.g., like a parabolic reflector); enables CTE matching to a backing structure by altering the ratio CNT to silicone; and has a high flatness which results in a reduced cross-polarization loss compared to gold-moly mesh.

Method 900 provides a solution for forming a CNT/elastomer reflector surface.

Method 900 generally involves: creating or obtaining a CNT material; cutting the CNT material into a plurality of shaped pieces; and sandwiching the CNT material between elastomer layers to form an antenna reflector surface with relatively high bending flexibility out-of-plane and relatively low modulus of elasticity.

As shown in FIG. 9A, method 900 begins with 902 and continues with obtaining a sheet of CNT material. In some scenarios, a CNT material is optionally formed using a CNT yarn as shown by 904 and 906. In other scenarios, the CNT material is not formed of a CNT yarn, but instead is formed by laser cutting a mesh pattern into a sheet of CNT material as shown by 904 and 908. In other cases, the CNT material is a solid sheet with no openings.

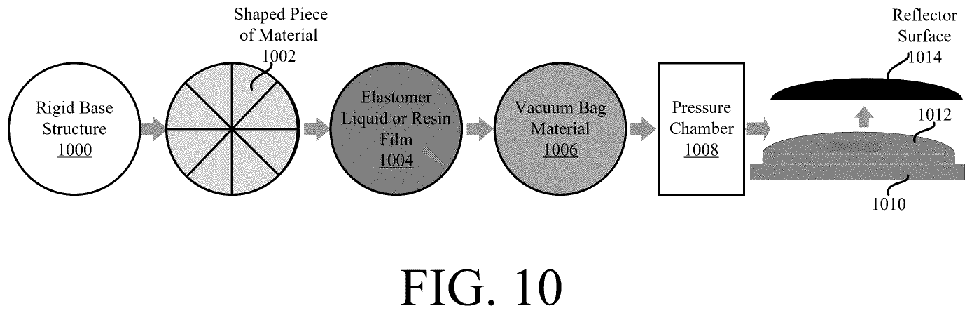

In 910, the CNT material is cut into a plurality of shaped pieces. The shaped pieces can include, but is not limited to, wedge pieces or other shaped pieces. The number N of shaped pieces is selected in accordance with a particular application. For example, N can be selected based on a desired geometry of an antenna reflector surface. N can be any integer greater than 2. The shaped pieces can have the same or different overall dimensions. Thus, in some scenarios, the shaped pieces match each other geometrically. In other scenarios, the shaped pieces are different geometrically such that one shaped piece has at least one dimension that is smaller than that of the other shaped piece(s). An illustration of shaped pieces 1002 of CNT material is provided in FIG. 10.

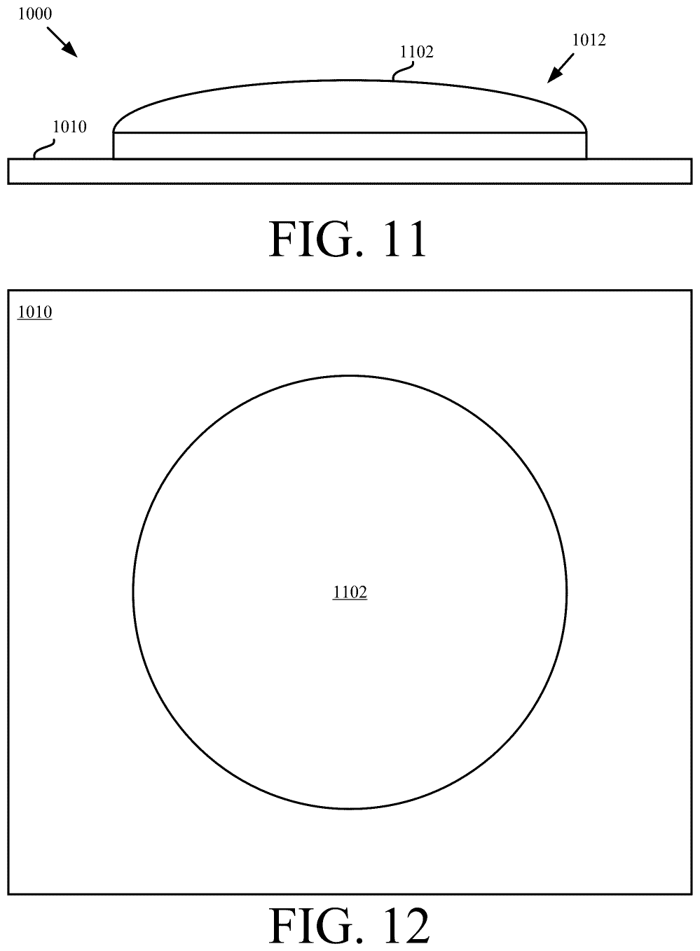

Next in 912, a rigid base structure is obtained. Illustrations of a rigid base structure 1000 are provided in FIGS. 10-12. Side views of the rigid base structure 1000 are provided in FIGS. 10 and 11. A top view of the rigid base structure is provided in FIG. 12. As shown in FIGS. 10-12, the rigid base structure 1000 comprises a platen 1010 and a rigid mold structure 1012 that is coupled to or integrated with the platen 1010. The rigid mold structure 1012 projects out and away from the platen. The rigid mold structure 1012 comprises a three dimensional (3D) contoured surface. The 3D contoured surface may be convex or parabolic.

The present solution is not limited to the particular architecture of the rigid base structure shown in FIGS. 10-12.

Referring again to FIG. 9A, method 900 continues with 914 where a release agent is obtained. The release agent can include, but is not limited to, films, waxes, sheets and release liners. For example, the release agent may consist of a release film having a product number A5000 which is available from Eagle Alloy Corporation of Tennessee. If the release agent comprises a sheet, it may be cut into wedge or other shaped pieces. The number of shaped pieces cut here can be the same as and/or different than the number of shaped pieces cut in 910. Also, the overall size and/or shape of the shaped pieces cut in 914 can be the same as or different than that of the shaped pieces cut in 910. The shaped pieces of 914 can have the same or different overall dimensions. Thus, in some scenarios, the shaped pieces match each other geometrically. In other scenarios, the shaped pieces are different geometrically such that one shaped piece has at least one dimension that is smaller than that of the other shaped piece(s).

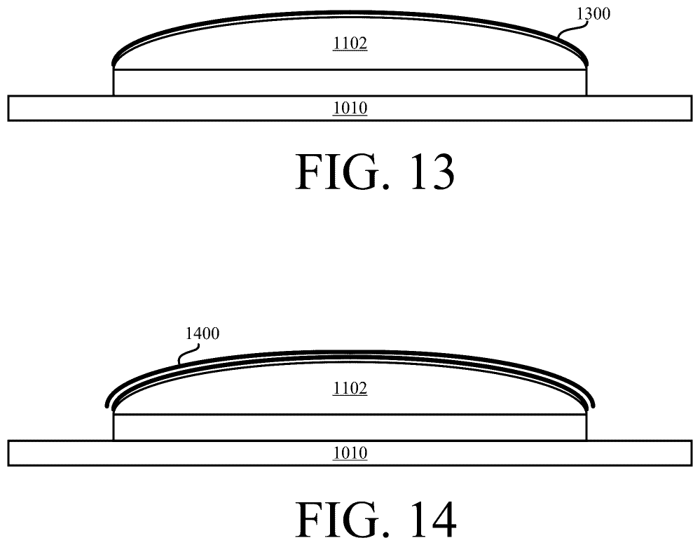

In 916, the release agent is optionally disposed on the rigid base structure. The release agent can be disposed in a manner so that (i) the release agent conforms to the same profile of the 3D contoured surface and (ii) has no surface abnormalities (e.g., wrinkles, ridges, bumps, depressions, folds, etc.). An illustration showing a release agent 1300 disposed on the rigid base structure 1000 is provided in FIG. 13.

In 918, an elastomer layer is applied to or otherwise disposed on the release agent and/or base structure. The elastomer layer can include, but is not limited to, a liquid elastomer or an elastomer resin film. An illustration is provided in FIG. 14 showing an elastomer layer 1400 on the release agent 1300.

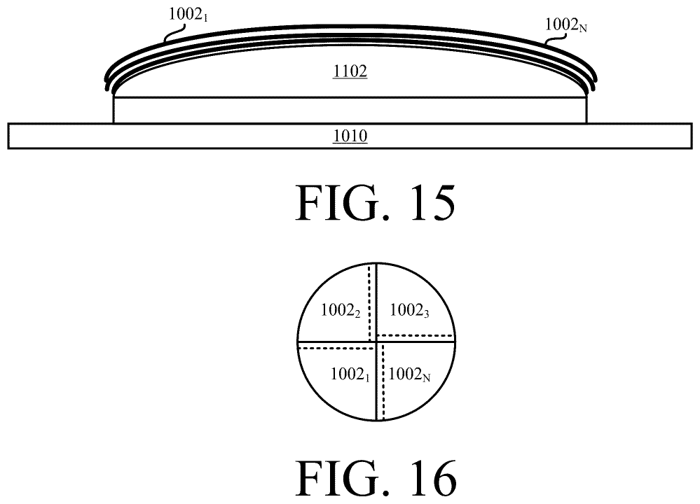

In 920, the shaped pieces of CNT material are disposed on the elastomer layer. An illustration showing shaped pieces 1002₁, . . . 1002_{N} of CNT material disposed on the elastomer layer 1400 are provided in FIG. 15. The shaped pieces may be disposed in an overlapping arrangement. The amount of overlap between two shaped pieces may be selected in accordance with any given application. An illustration showing shaped pieces 1002₁, 1002₂, 1002₃, 1002_{N} of CNT material having an overlapping arrangement is provided in FIG. 16. As shown in FIG. 16, shaped piece 1002₁ overlaps shaped piece 1002₂. Shaped piece 1002₂ overlaps shaped piece 1002₃. Shaped piece 1002₃ overlaps shaped piece 1002₄. Shaped piece 1002₄ overlaps shaped piece 1002₁. The present solution is not limited to the particular overlapping arrangement of FIG. 16.

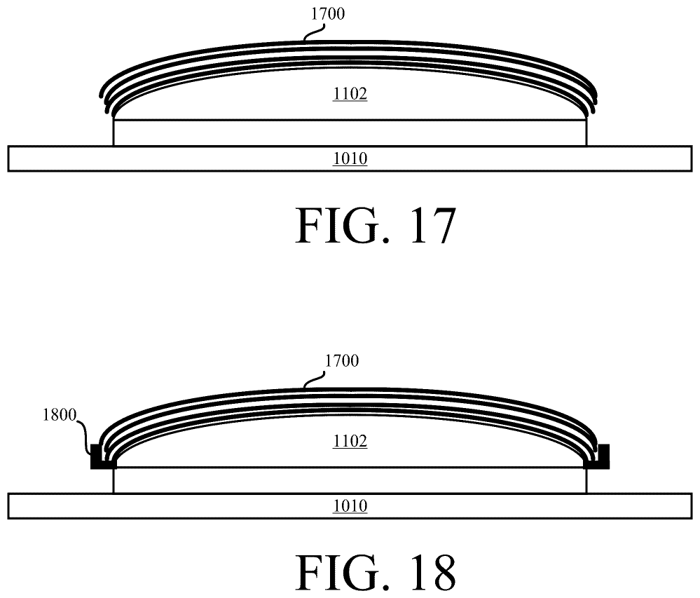

In 922, another elastomer layer is applied to or otherwise disposed on the layer of CNT material. The elastomer layer can include, but is not limited to, a liquid elastomer or an elastomer resin film. An illustration showing another elastomer layer 1700 disposed on the CNT material is provided in FIG. 17.

In 924, method 900 may optionally return to block 920 so that other alternating layers of CNT material and elastomer can be applied or otherwise disposed to complete the stack (e.g., stack 800 of FIG. 8). The elastomer provides a means to bond the shaped pieces together to form a flexible composite material which has increased mechanical strength.

Next in 926, a dam material/structure is placed adjacent to the edge of the stack adhesive and/or encompasses a perimeter of the stack. The dam material/structure can be selected in accordance with any given application. The dam material can include, but is not limited to, a rubber based sheet material, silicone, cork, tape, Invar tabs, metal, and/or any other material that will block, obstruct or otherwise prevent the flow of the elastomer liquid or resin film out of a given area during a subsequent curing process. An illustration showing a dam material/structure 1800 placed adjacent to the stack's edge is provided in FIG. 18.

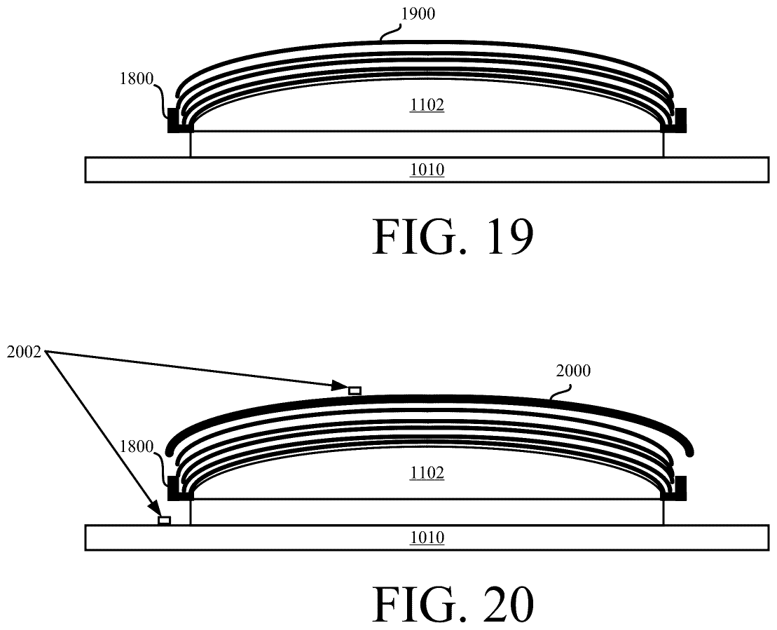

In 928, a release agent is disposed on the dam/material structure or stack. The release agent can be the same or different than the release agent used in 916. An illustration showing a release agent 1900 disposed on the resin film adhesive 1100 is provided in FIG. 19.

In 930, a caul structure is placed on the release agent. The caul structure comprises one or more structural pieces that are free of surface defects. Each structural piece has a shape that conforms to the 3D contoured surface of the rigid mold structure. The caul plate is used to transmit pressure and temperature to the stack of materials during a subsequent curing process.

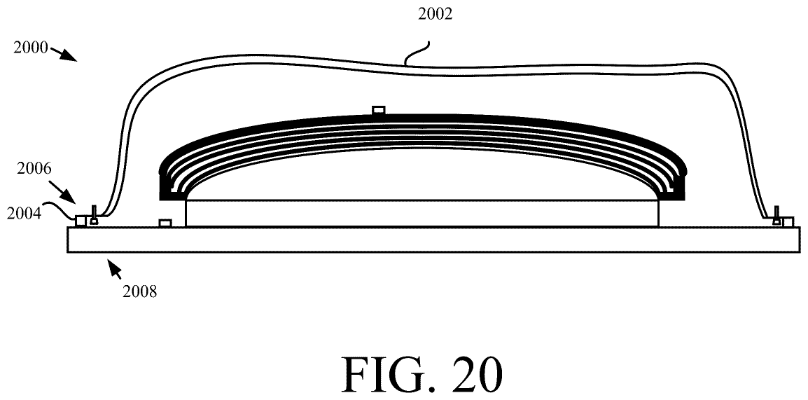

The caul plate facilitates the provision of a smooth surface on the finished product (i.e., an antenna reflector surface). In this regard, the caul plate prevents the shaped pieces of CNT material from wrinkling or otherwise experiencing surface abnormalities during curing. An illustration showing a caul structure 2000 disposed on the release agent 1900 is provided in FIG. 20.

In 932, one or more sensors is installed or otherwise disposed to the caul structure and/or the platen. The sensor(s) is(are) provided to monitor the characteristics of the stack of materials (e.g., materials 1300, 1402, 1002, 1700, 1900) and/or a particular material (e.g., the CNT material 1002) in the stack during a subsequent curing process. The characteristics can include, but are not limited to, temperature, stress, surface smoothness, and/or pressure. The sensors can include, but are not limited to, thermocouples, a pressure sensor, a strain gauge, and/or a camera. Each of the listed sensors is well known. An illustration showing sensors 2002 disposed on the caul structure 2000 is provided in FIG. 20.

Thereafter, method 900 continues with 934 of FIG. 9B where a vacuum bag assembly is assembled. A side view of an assembly vacuum bag assembly 2100 is provided in FIG. 21.

As shown in FIG. 21, the vacuum bag assembly 2100 is comprises of a vacuum bag material 2102 disposed on the caul structure 2000. The vacuum bag material 2102 comprises any bag material that can withstand heat and pressure of the subsequent curing process, and that would not interfere with the curing of the resin film adhesive. For example, the bag material can be a flexible dimensionally stable film having product number P/N HS-6262 which is available from Solvay USA Inc. of West Virginia, or Kapton® available from E.I. Du Pont De Nemours and Company of Wilmington, Delaware. The vacuum bag material 2102 forms a seal with the rigid base structure 1000. For example, an outer rim 2106 of the vacuum bag material is coupled to an outer rim 2108 of the rigid base structure with a sealant means 2104. The sealant means includes, but is not limited to, a mechanical connector means, a sealant tape, epoxy, adhesive, and/or glue.

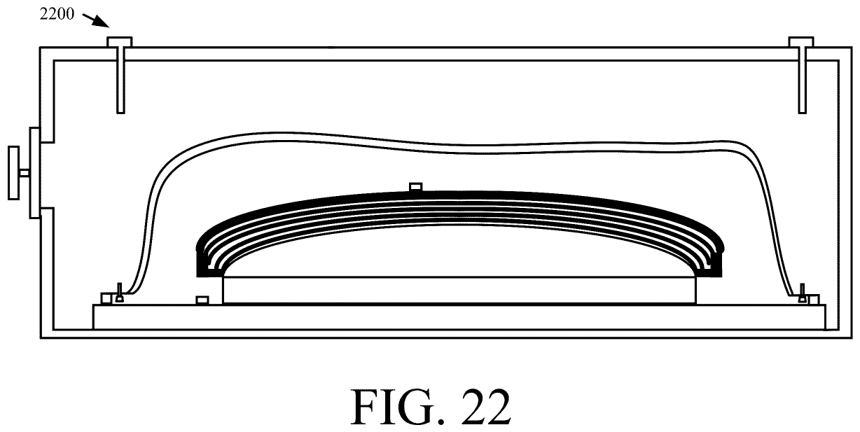

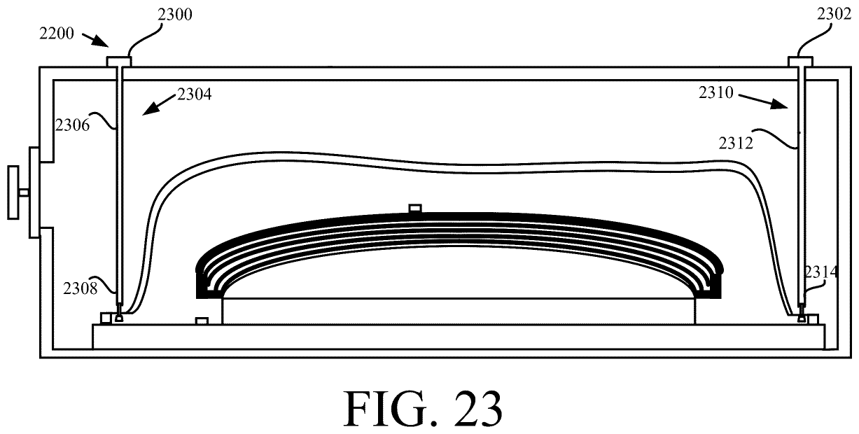

Upon completing 934, method 900 continues with 936 which involves placing the vacuum bag assembly in a vacuum chamber. An illustration of the vacuum bag assembly 2100 disposed in a vacuum chamber 2200 is provided in FIG. 22. In this regard, it should be appreciated that the vacuum chamber 2200 is a container in which heat and pressure can be applied to the materials disposed therein. The vacuum chamber 2200 can include, but is not limited to, an autoclave. The autoclave can be selected as an autoclave in which temperature and/or pressure sequences can be software defined and pre-programmed into a memory of the autoclave. For example, the autoclave is an Econo-clave® available from ACS Process Systems of Sylmar, California. The invention is not limited in this regard.

In next block 938, the vacuum bag assembly is coupled to a vacuum pump and a vacuum gauge. A leak free connection between the vacuum bag assembly and each of the listed devices is necessary for forming an antenna reflector surface by applying different amounts of pressure thereto. An illustration of the vacuum bag assembly 2100 coupled to a vacuum pump 2300 and a vacuum gauge 2302 is provided in FIG. 23. A coupling means 2304 is provided for coupling the vacuum bag material 2102 to the vacuum pump 2300. The vacuum pump 2300 is provided for selectively reducing a pressure in an interior volume of the vacuum bag material 2102 by evacuating at least a portion of a gas contained therein. The coupling means 2304 is comprised of a tubular conduit 2306 and a connector means 2308. The tubular conduit 2306 is selected in accordance with a particular vacuum bag assembly application. For example, the tubular conduit 2306 is selected as a flexible tube-like structure formed of a material suitable to withstand high temperatures and pressures. The connector means 2308 is configured to maintain a leak-free seal between the vacuum bag material 2302 and the tubular conduit 2306 at high temperatures and pressures. For example, the connector means 2308 is comprised of a top bolt, a seal ring, and a threaded valve base having a vacuum feed through aperture. The present solution is not limited in this regard.

A coupling means 2310 is also provided for coupling the vacuum bag material 2102 to the vacuum gauge 2302. The vacuum gauge is provided for tracking pressures inside the vacuum bag assembly 2100. The coupling means 2310 comprises a tubular conduit 2312 and a connector means 2314. The tubular conduit 2312 is selected in accordance with a particular vacuum bag apparatus application. For example, the tubular conduit is selected as a flexible tube-like structure formed of a material suitable to withstand high temperatures and pressures.

The connector means 2314 is configured to maintain a leak-free seal between the vacuum bag material 2102 and the tubular conduit 2312 at high temperatures and pressures. For example, the connector means 2314 is comprised of a top bolt, a seal ring, and a threaded valve base having a vacuum feed through aperture. The present solution is not limited in this regard.

Referring again to FIG. 9B, method 900 continues with 940 where the vacuum pump is used to reduce a pressure in an interior volume of the vacuum bag assembly. This pressure reduction can be achieved by evacuating at least a portion of a gas contained in the interior volume of the vacuum bag assembly. In some scenarios, the gas contained in the interior volume of the vacuum bag assembly is evacuated to at least −20 inches mercury (or 10-14.7 PSI) of pressure inside vacuum bag assembly. The present solution is not limited in this regard.

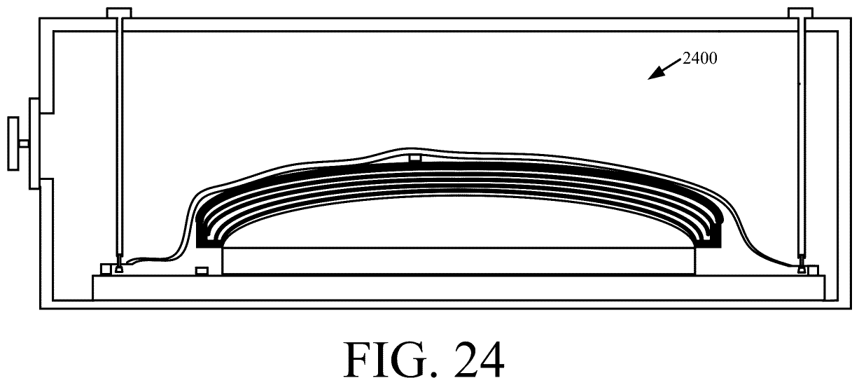

An illustration of an at least partially evacuated vacuum bag assembly 2100 is provided in FIG. 24. At least a portion of the gas contained in the interior volume of the vacuum bag assembly has been evacuated through use of the vacuum pump. As such, a pressure inside the interior volume is reduced. In effect, a pressure differential is created between a pressure in the interior volume and a pressure in an environment external to the vacuum bag assembly.

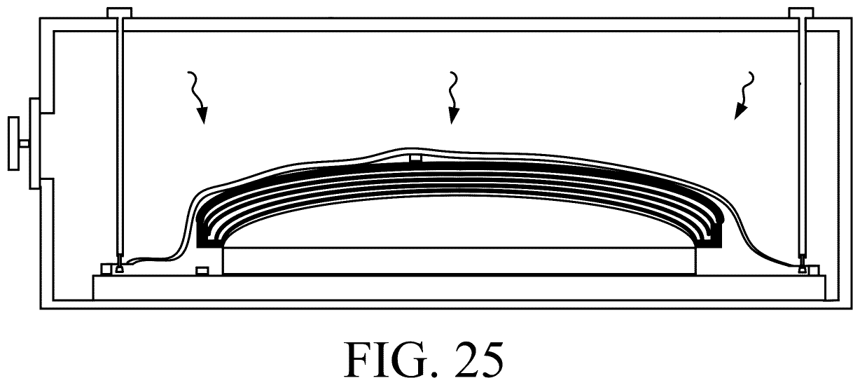

In block 942 of FIG. 9B. heat is applied to the vacuum bag assembly to reduce a viscosity of the resin film adhesive so that the elastomer liquid or resin film flows into the CNT material. In some scenarios, heat inside the vacuum chamber is increased in 942 until the temperature of the CNT material reaches 140° F. The present solution is not limited in this regard. An illustration showing heat being applied to the vacuum bag assembly 2100 is provided in FIG. 25.

Next in block 944, the temperature of the CNT material is maintained for a given period of time (e.g., 1 hour). This ensures that the elastomer liquid or resin film flows into the CNT material. Once the period of time expires, the vacuum suction and/or seal is released as shown by 946. 946 involves turning off the vacuum pump to let the pressure inside vacuum bag assembly equilibrate to the pressure of the surrounding environment inside vacuum chamber. By performing this vacuum suction/seal release between two heating cycles, the shaped pieces of CNT material are prevented from wrinkling or otherwise deforming due to cure stresses.

Thereafter, the stack is allowed to cool as shown by 948. The vacuum bag assembly is removed from the vacuum chamber in 950. The vacuum bag material is removed from the vacuum bag apparatus as shown by 952. The caul structure and release agent are also removed from the assembly in 952. In 954, the fabricated CNT/elastomer material is removed from the 3D contoured surface of the rigid base structure. The CNT/elastomer material is then optionally used in 956 as an antenna reflector surface (e.g., antenna reflector 102 of FIG. 1). Subsequently, 958 is performed where method 900 ends or other operations are performed.

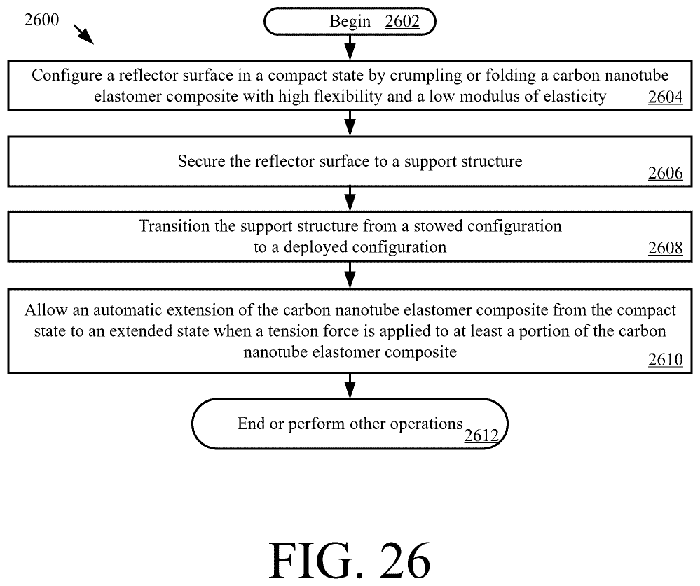

FIG. 26 provides a flow diagram of an illustrative method 2600 for deploying a reflector system (e.g., reflector system 100 of FIG. 1). Method 2600 begins with 2602 and continues with 2604 where a reflector surface (e.g., reflector surface 106 of FIG. 1) is configured in a compact state by crumpling or folding a carbon nanotube elastomer composite (e.g., CNT/elastomer material 800 of FIG. 8) with high bending flexibility out-of-plane and a low modulus of elasticity. Next in 2606, the reflector surface is secured to a support structure (e.g., hoop assembly 102 of FIG. 1). The support structure is transitioned from a stowed configuration to a deployed configuration in block 2608. An automatic extension of the carbon nanotube elastomer composite is allowed in block 2610 from the compact state to an extended state when a tension force is applied to at least a portion of the carbon nanotube elastomer composite during the transitioning of block 2608. Subsequently, method 2600 continues to block 2612 where it ends or other operations are performed.

In view of the forgoing discussion, the present solution concerns deployable reflector systems. These systems comprise a support structure and a reflector surface connected to the support structure. The reflector surface is comprised of a carbon nanotube elastomer composite with high bending flexibility out-of-plane and a low modulus of elasticity. The support structure is configured to transition from a compact stowed configuration to a larger deployed configuration.

The carbon nanotube elastomer composite comprises (i) a carbon nanotube material sandwiched between two layers of an elastomer and/or (ii) a stack of alternating layers of a carbon nanotube material and an elastomer. The carbon nanotube composite is a flexible material configured to be crumpled or folded in a plurality of different manners without causing damage to the carbon nanotube material. The carbon nanotube elastomer composite may be configured to be crumpled and/or folded in accordance with a folding pattern to define a compact state when the support structure is in the stowed configuration, and to automatically transition from the compact state to an extended state when a tension force is applied to at least a portion of the carbon nanotube elastomer composite by the support structure. The elastomer can include, but is not limited to, a cured silicone liquid or resin film. The carbon nanotube elastomer composite may be designed or otherwise configured to: have a certain coefficient of thermal expansion by adjusting a volume ratio of a carbon nanotube sheet to elastomer within a composite material; and/or match a bulk coefficient of thermal expansion of a support structure.

The support structure may comprise a circumferential hoop. The reflector surface may have an outer peripheral edge that is secured to the circumferential hoop. The circumferential hoop in the compact state may have a first diameter that is minimized for compact storage, and in a larger deployed configuration has a second diameter larger than the first diameter.

The present solution also concerns methods for deploying a reflector system. The methods comprise: configuring a reflector surface in a compact state by crumpling or folding a carbon nanotube elastomer composite with high bending flexibility out-of-plane and a low modulus of elasticity; securing the reflector surface to a support structure; transitioning the support structure from a stowed configuration to a deployed configuration; and allowing an automatic extension of the carbon nanotube elastomer composite from the compact state to an extended state when a tension force is applied to at least a portion of the carbon nanotube elastomer composite during said transitioning.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the embodiments have been illustrated and described with respect to one or more implementations, equivalent alterations and modifications will occur to others skilled in the art upon the reading and understanding of this specification and the annexed drawings. In addition, while a particular feature of an embodiment may have been disclosed with respect to only one of several implementations, such feature may be combined with one or more other features of the other implementations as may be desired and advantageous for any given or particular application. Thus, the breadth and scope of the embodiments disclosed herein should not be limited by any of the above described embodiments. Rather, the scope of the invention should be defined in accordance with the following claims and their equivalents.

We claim:

1. A deployable reflector system, comprising:
a support structure; and
a reflector surface connected to the support structure;
wherein the reflector surface is comprised of a carbon nanotube elastomer composite with high bending flexibility out-of-plane and a low modulus of elasticity; and
wherein the support structure is configured to transition from a compact stowed configuration to a larger deployed configuration.

2. The deployable reflector system according to claim 1, wherein the carbon nanotube elastomer composite comprises a carbon nanotube material sandwiched between two layers of an elastomer.

3. The deployable reflector system according to claim 2, wherein the carbon nanotube composite is a flexible material configured to be crumpled or folded in a plurality of different manners without causing damage to the carbon nanotube material.

4. The deployable reflector system according to claim 1, wherein the carbon nanotube elastomer composite is configured to have a certain coefficient of thermal expansion by adjusting a volume ratio of a carbon nanotube sheet to elastomer within a composite material.

5. The deployable reflector system according to claim 1, wherein the carbon nanotube elastomer composite is configured to match a bulk coefficient of thermal expansion of a support structure.

6. The deployable reflector system according to claim 1, wherein the carbon nanotube elastomer composite comprises a stack of alternating layers of a carbon nanotube material and an elastomer.

7. The deployable reflector system according to claim 1, wherein the carbon nanotube elastomer composite is configured to be crumpled to define a compact state when the support structure is in the stowed configuration, and to automatically transition from the compact state to an extended state when a tension force is applied to at least a portion of the carbon nanotube elastomer composite by the support structure.

8. The deployable reflector system according to claim 1, wherein the carbon nanotube elastomer composite is configured to be folded in accordance with a folding pattern to define a compact state when the support structure is in the stowed configuration, and to automatically transition from the compact state to an extended state when a tension force is applied to at least a portion of the carbon nanotube elastomer composite by the support structure.

9. The deployable reflector system according to claim 1, wherein the elastomer comprises a cured silicone liquid or resin film.

10. The deployable reflector system according to claim 1, wherein the support structure comprises a circumferential hoop.

11. The deployable reflector system according to claim 10, wherein the reflector surface has an outer peripheral edge that is secured to the circumferential hoop.

12. The deployable reflector system according to claim 11, wherein the circumferential hoop in the compact state has a first diameter that is minimized for compact storage, and in a larger deployed configuration has a second diameter larger than the first diameter.

13. A method for deploying a reflector system, comprising:
configuring a reflector surface in a compact state by crumpling or folding a carbon nanotube elastomer composite with high bending flexibility out-of-plane and a low modulus of elasticity;
securing the reflector surface to a support structure;
transitioning the support structure from a stowed configuration to a deployed configuration; and
allowing an automatic extension of the carbon nanotube elastomer composite from the compact state to an extended state when a tension force is applied to at least a portion of the carbon nanotube elastomer composite during said transitioning.

14. The method according to claim 13, wherein the carbon nanotube elastomer composite comprises a carbon nanotube material sandwiched between two layers of an elastomer.

15. The method according to claim 14, wherein the carbon nanotube composite is a flexible material configured to be crumpled or folded in a plurality of different manners without causing damage to the carbon nanotube material.

16. The method according to claim 13, wherein the carbon nanotube elastomer composite is configured to have a certain coefficient of thermal expansion by adjusting a volume ratio of a carbon nanotube sheet to elastomer within a composite material.

17. The method according to claim 13, wherein the carbon nanotube elastomer composite is configured to match a bulk coefficient of thermal expansion of a support structure.

18. The method according to claim 13, wherein the carbon nanotube elastomer composite comprises a stack of alternating layers of a carbon nanotube material and an elastomer.

19. The method according to claim 13, wherein the carbon nanotube elastomer composite is configured to be crumpled to define the compact state when the support structure is in the stowed configuration, and to automatically transition from the compact state to the extended state when a tension force is applied to at least a portion of the carbon nanotube elastomer composite by the support structure.

20. The method according to claim 13, wherein the carbon nanotube elastomer composite is configured to be folded in accordance with a folding pattern to define the compact state when the support structure is in the stowed configuration, and to automatically transition from the compact state to the extended state when a tension force is applied to at least a portion of the carbon nanotube elastomer composite by the support structure.

21. The method according to claim 13, wherein the elastomer comprises a cured silicone liquid or resin film.

22. The method according to claim 13, wherein the support structure comprises a circumferential hoop.

23. The method according to claim 22, wherein the reflector surface has an outer peripheral edge that is secured to the circumferential hoop.

24. The method according to claim 23, wherein the circumferential hoop in the compact state has a first diameter that is minimized for compact storage, and in a larger deployed configuration has a second diameter larger than the first diameter.
